(19) United States
(12) Patent Application Publication
(10) Pub. No.: US 2003/0035682 A1
(43) Pub. Date: Feb. 20, 2003

(54) Multi-direction bendable tube structure

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/931,885

(22) Filed: Aug. 20, 2001

(51) Int. Cl. F16B 7/10

(52) U.S. Cl. 403/109.7

(57) ABSTRACT

A multiple-direction bendable tube structure comprises a tube cut into a primary section and a secondary section joined by a clamp; a groove provided axially in the wall of the end where the secondary section connects the primary section; a positioning member inserted by a core pin pivoted to the clamp between free ends of the clamp attached with a fast wrench; the positioning member inserted into the groove to form at its inner end a conic stopper protruding inside the primary section while a longitudinal groove corresponding to the conic stopper of the positioning member being formed on the tube surface where the secondary section inserted into the primary section; a fixing member is connected to the end of the secondary section; and an elastic cord connects the fixing member and the buffer stop for the end having the fixing member of the secondary section to be inserted into the primary section and secured therein by the clamp provided with the fast wrench, or having the buffer stop to move until restricted by the conic stopper when the clamp is released to pull out the secondary section from the primary section for the secondary section to be bent at any direction as desired by stretching the elastic cord.

### BACKGROUND OF THE INVENTION

(a) Field of the Invention

The present invention relates to a multi-direction bendable tube structure, and more particularly, to one having multiple tube sections abutted with an elastic cord for any of the sections to be bent towards any direction as desired when disengaged from its abutted status.

(b) Description of the Prior Art

To achieve being compact for easy portability, many products are foldable to reduce storage space required. The basic configuration of most of those foldable products generally available in the market uses a tube frame as support. The reason is that once it is expanded, it consumes quire a lot space. Therefore, a foldable structure is required to incorporate to the configuration of tubular frame. Taking a regular bike and the skating board with handle so popular today for examples, pivot joints are generally provided to those longer and higher frames so to fold in or retract or shorten tubes comprised of said frame to facilitate carriage or storage.

However, the prior art of foldable frame of a bike or a scooter with handle is simply to have the tube cut into two sections and pivoted by a joint. Consequently, the spot of said pivot joint is always exposed, and it allows only to be bent in one single direction since said pivot joint refers to a rigid structure. Accordingly, said pivot joint must be designed for inclination in coping with a certain product of a configuration that requires askew folding in, or requires a rotation to incorporate the entire framework of said pivot joint. In either case, it will add difficulties in structural planning and inconvenience in folding.

### SUMMARY OF THE INVENTION

The primary purpose of the present invention is to provide a multi-direction bendable tube structure. To achieve the purpose, an elastic cord is used to connect abutted sections of a tube so that either may be bent at any direction when it is pulled out to disengage from where it is abutted. Wherein, a tube is cut into a primary section and a secondary section. A groove is provided axially on the wall of the connection of the primary section in relation to the secondary section, and is inserted with a clamp having a fast wrench; the clamp is provided with a fixing bolt to pass through the primary section and hold against a fixing hole to be secured in position; a positioning member is penetrated by a core pin pivoted to the clamp through an axis between free ends of a ring of the clamp for receiving the penetration of the fast wrench; the positioning member then passes and rest on the groove to form at inner end a conic stopper protruding into the primary section; a buffer stop is provided in the primary section and is prevented from escaping for being subject to the conic stopper of the positioning member; the secondary section is inserted into the tube end where the primary section is connected to the clamp; a longitudinal chute is formed on the tube area the secondary section is inserted at where corresponding to the conic stopper of the positioning member; a fixing member is connected to the end of the insertion and an elastic cord is separately provided to connect the fixing member to the buffer stop in the primary section; so that the end provided with the fixing member of the secondary section matches the conic stopper of the positioning member to be inserted into the primary section in a certain direction; both sections are tightened up with the clamp provided with the fast wrench, or the clamp is released to pull out the secondary section for the buffer stop to hold against the conic stop of the positioning member, thus further to disengage the secondary section from the primary section by pulling to extend the elastic cord, finally, the second section can be bend in any direction desired relative to the primary section by taking advantage of the connection of the elastic cord.

### BRIEF DESCRIPTION OF THE DRAWINGS

FIG. 1 is an exploded view of a preferred embodiment of the present invention.

FIG. 2 is a side view showing that the preferred embodiment of the present invention is applied in an assembly of a bike.

FIG. 3 is a cross-sectional view showing a local part of the preferred embodiment of the present invention in an assembly of a bike.

FIG. 4 is a view showing the folding of the preferred embodiment of the present invention applied in a bike.

FIG. 5 is a view showing that the preferred embodiment of the present invention applied in a bike when folded in.

FIG. 6 is a view showing that the preferred embodiment of the present invention is applied in a scooter.

FIG. 7 is a view showing that the preferred embodiment of the present invention is applied in a scooter when folded for storage.

### DETAILED DESCRIPTION OF THE PREFERRED EMBODIMENTS

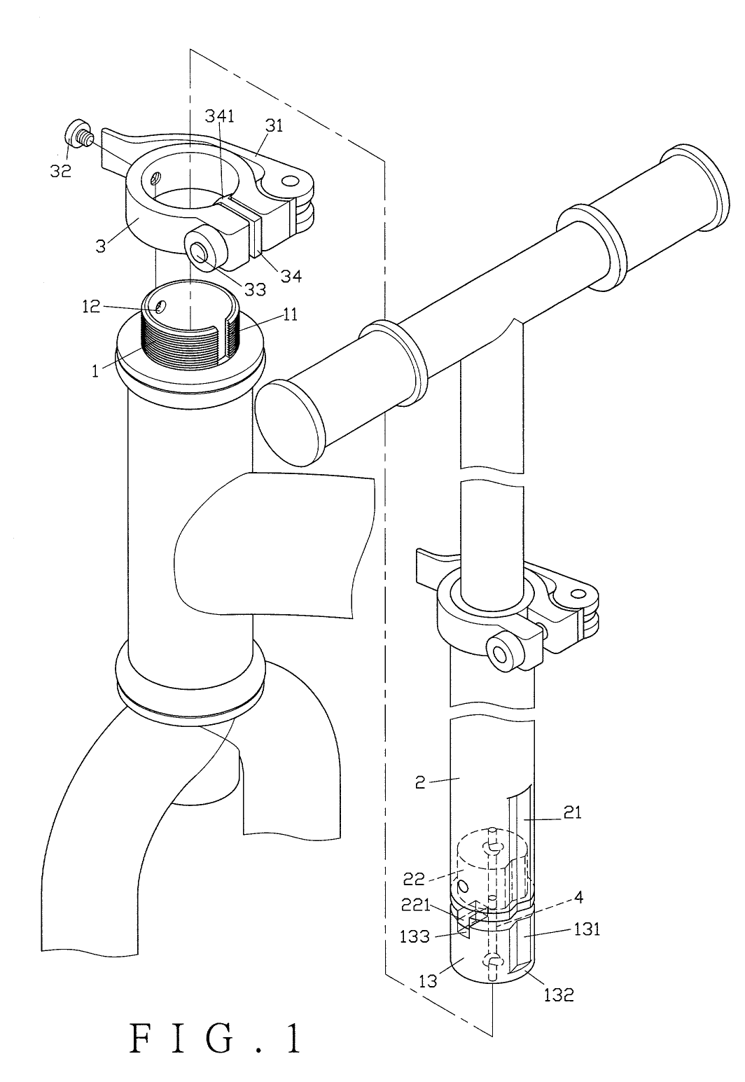

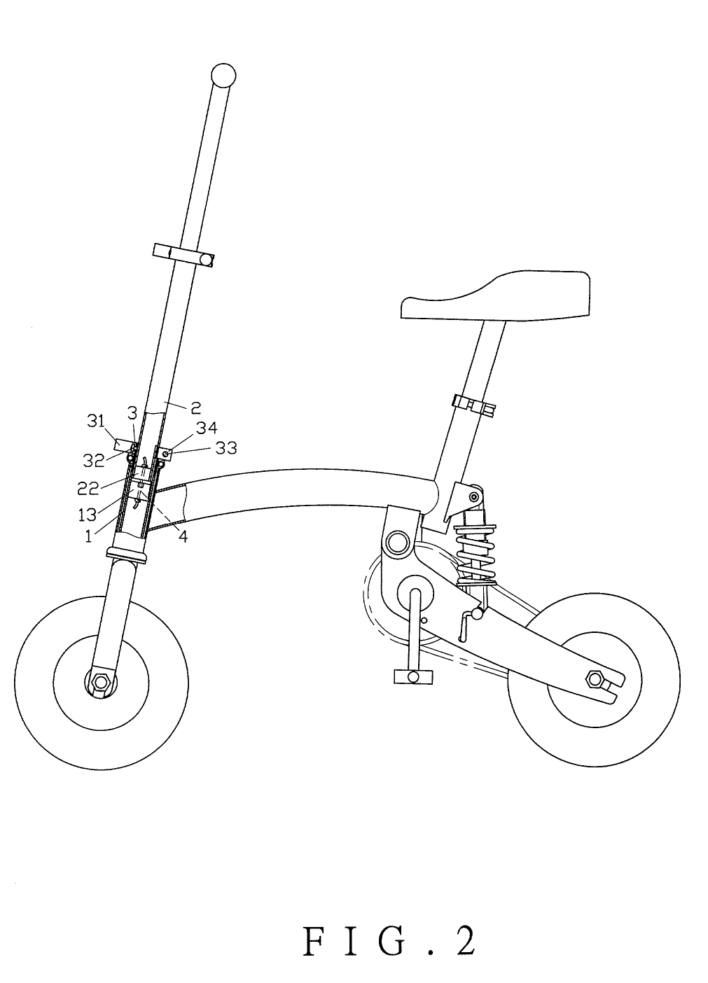

Referring to FIGS. 1 and 2, a preferred embodiment of the present invention is applied in a bike. Wherein a multiple-direction bendable tube of the present invention essentially comprises a tube cut into a primary section (1) and a secondary section (2) provided at where a head tube is connected to a fork. That is, the primary section (1) operates as a pivot for the fork and the secondary section (2) as the head tube connected to the handle of the bike. The secondary section (2) can be inserted into and secured in the primary section (1) to form a handle for the bike.

The primary section (1) provides a groove (11) axially in the tube wall at where the primary section (1) connecting to the secondary section (2), and is inserted to a clamp (3) having a fast wrench (31). A fixing bolt (32) is bored through the clamp (3) and a fixing hole (12) in the primary section (1) to hold the clamp (3) in position. A core pin (33) pivoted to the fast wrench (31) penetrates a positioning member (34) between both free ends of the clamp (3). The positioning member (34) passes through the groove (11) to form at the inner end of the positioning member (34) a conic stopper (341) protruding inside the primary section (1). A buffer stop (13) is provided inside the primary section (1) functioning as the pivot for the fork of the bike, and then is connected to the clamp (3) and the positioning member (34). A longitudinal chute (131) is provided on the side of the buffer stop (13) at where corresponding to the conic stopper (341) of the positioning member (34) and an inherited circular portion at the lower end of the chute (131) constitutes a stopper (132).

A longitudinal chute (21) corresponding to the conic stopper (341) of the positioning member (34) is formed on the secondary section (2) inserted to the primary section (1), and a relative tubular fixing member (22) is connected to the end where the secondary section (2) enters into the primary section (1). An elastic cord (4) is used to connect the fixing member (22) at the end of the secondary section (2) to the buffer stop (13) inside the primary section (1) in a way to allow both of the fixing member (22) and the buffer stop (13) be abutted at a short range by being subject to the pull of the elastic cord (4). In such a status, abut ends respectively from the fixing member (22) and the buffer stop (13) are provided with a convex (221) and a concave (133) SO that when both of the convex (221) and the concave (133) are abutted, the chute (21) in the secondary section (2) and the chute (131) from the buffer stop (131) are on the same orientation to move along the conic stopper (341) of the positioning member (34).

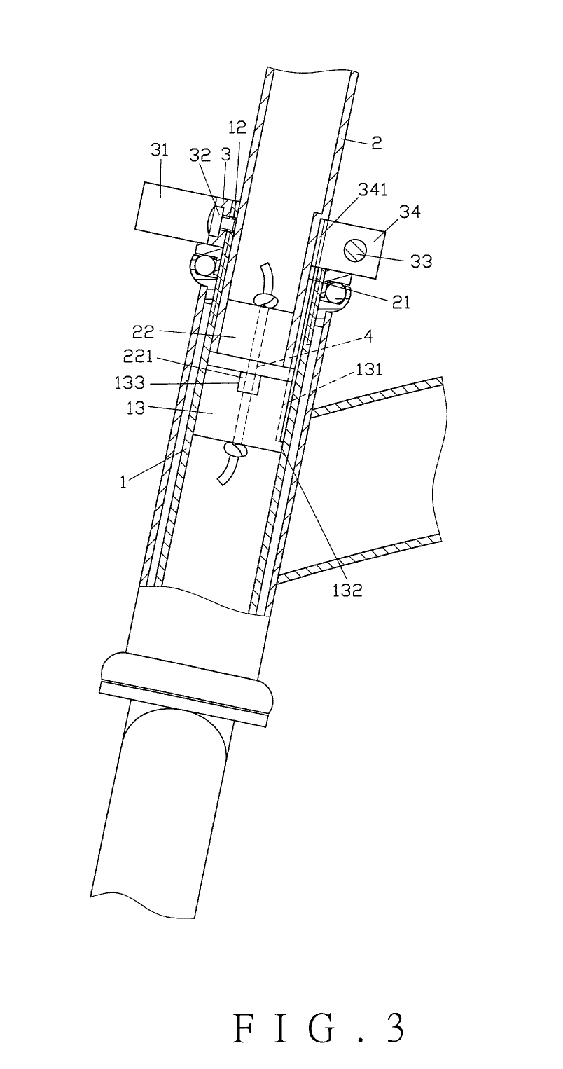

When the structure as disclosed above is applied to the handle of a bike as illustrated in FIGS. 2 and 3, the portion provided with the fixing member (22) of the secondary section (2) is inserted for combination in a mode of single direction by having the chute (21) provided on the tube surface to correspond to the conic stopper (341) of the positioning member (34) on the primary section (1). Consequently, the secondary section (2) is prevented from turning in relation to the primary section (1) as the secondary section (2) can only execute vertical expansion for movement. Furthermore, with the conic stopper (341) holding against the upper end of the chute (21), the secondary section (2) is held in position after having been inserted into the primary section (1) for a proper depth and the fixing member (22) at the end of the secondary section (2) moves downward by means of the buffer stop (13) connected with the elastic cord (4). Then the fast wrench (31) is pressed for the clamp (3) to pack against the primary section (1) in relation to the end of the secondary section (2) inside the primary section (1) and secured to form a connection structure constituted by the elastic cord (4) and the buffer stop (13) that is hidden inside the primary section (1).

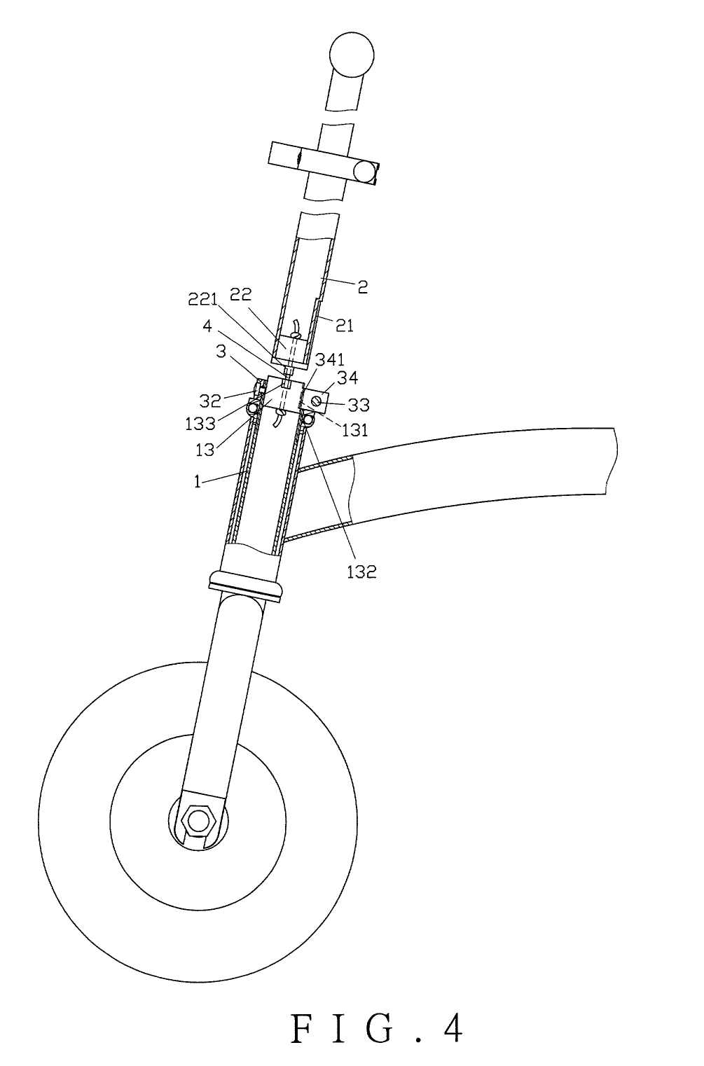

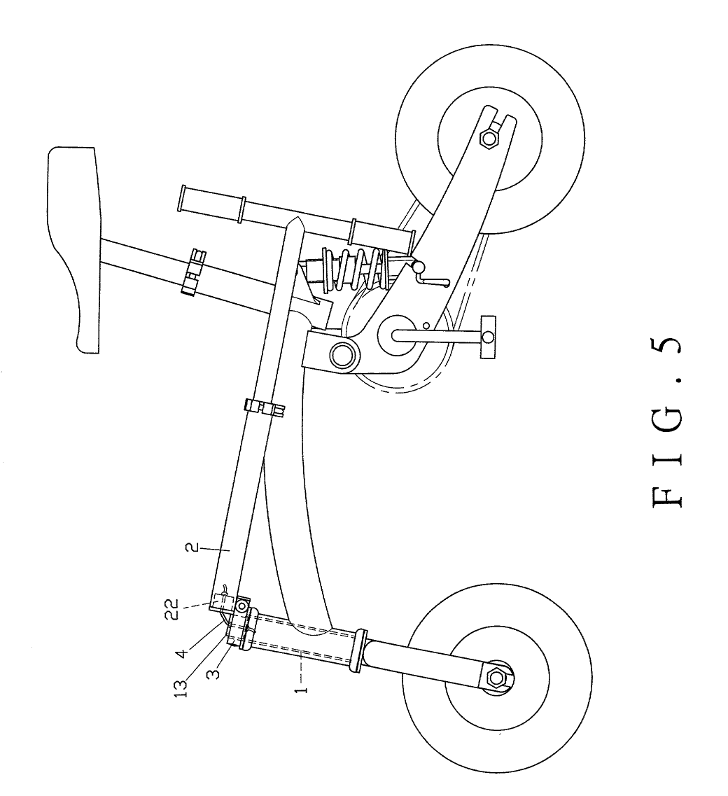

Upon folding in the head tube and the handle of the turning structure of the bike to rest on its frame as illustrated in FIG. 4, the fast wrench (31) is pulled to release the clamp (3) to pull out the end provided with the fixing member (22) of the secondary section (2). Under such condition, the buffer stop (13) is pulled up as the chute (131) slides along the conic stopper (341) of the positioning member (34). As the buffer stop (13) is held against the conic stopper (341) by the stopper (132) formed at the lower end of the chute (131), force is applied to pull the secondary section (2) to stretch the elastic cord (4) to disengage the convex (221) from the concave (133) that abut both of the fixing member (22) and the buffer stop (13). Now referring to FIG. 5, the secondary section (2) can be bent towards any direction as desired by taking advantage of the elastic cord (4) that connects both of the primary section (1) and the secondary section (2). Accordingly, the head tube and the handle of the bike can be folded in to rest on either side of the frame of the bike, or bend to any angle as desired to facilitate the folding in for storage.

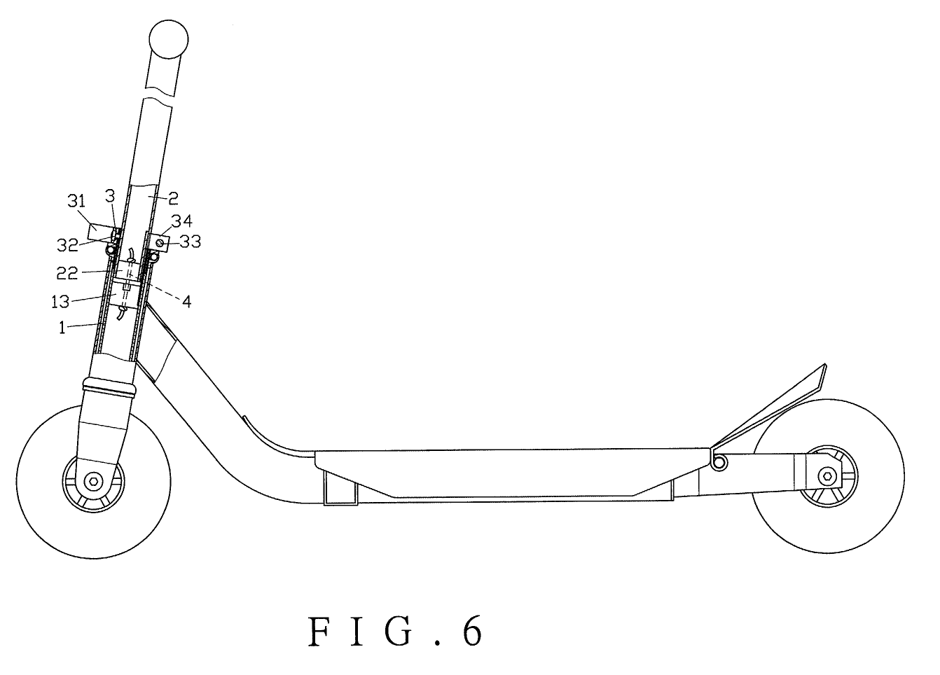

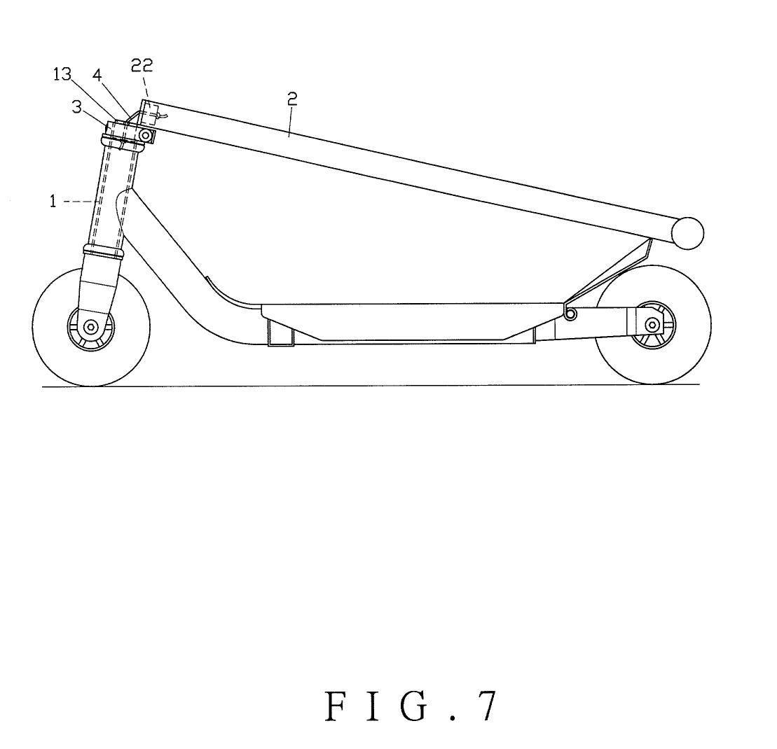

Now referring to FIGS. 6 and 7, the present invention is applied to a skating board with a handle. Wherein, the secondary section (2) is connected into the primary section (1) by having the fixing member (22) connected to the buffer stop (13) with the elastic cord (4) and by applying the configuration of fastening with the clamp (3) at where the lower end of the head tube of the handle of the skating board connects the pivot section of the fork in side the head tube. Similarly, the handle head tube can be folded in to rest on the board.

To sum up, the structure of a multiple-direction bendable tube of the present invention takes advantage of the elastic cord to connect the fixing member attached to the secondary section to the buffer stop inside the primary section for the elastic cord to allow the secondary section to be bent in any direction as desired in relation to the primary section with the secondary section being pulled out of the primary section but not separating from the primary section as restricted by the buffer stop.

I claim:

1. A multiple-direction bendable tube structure comprising a tube cut into a primary section and a secondary section, a clamp attached with a fast wrench connected to an end of said secondary section facing said primary section, and said secondary section inserted and held in position in the end of said primary section restricted by said clamp, characterized by that:
an elastic cord connected to the end wherein said secondary section inserting said primary section with the other end of said elastic cord entering into said primary section and connected to a buffer stop to restrict slide by said secondary tube; thus, said secondary section connected into said primary section being secured by said clamp or said buffer stop being holding against an inner end of said primary section when said clamp being released for said secondary section to disengage from said primary section to allow said secondary section to be bent at any direction in relation to said primary section as desired.

2. A multiple-direction bendable tube structure as claimed in claim 1, wherein, a groove is provided axially in the wall of the end where said secondary section is connected to said primary section, and said clamp having a fixing bolt to penetrate through a fixing hole in said primary section thus to hold said secondary section in position, a positioning member inserted by a core pin pivoted to said clamp between free ends of said clamp attached with said fast wrench, said positioning member inserted into said groove to form at its inner end a conic stopper protruding inside said primary section while a longitudinal chute corresponding to said conic stopper of said positioning member being formed on the tube surface where said secondary section inserted into said primary section; and a fixing member being connected to one end of said secondary section.

3. A multiple-direction bendable tube structure as claimed in claim 1, wherein, said buffer stop is placed inside said primary section before connecting to said clamp and said positioning member, a longitudinal chute corresponding to said conic stopper of said positioning member being provided on one side of said buffer stop, a stopper formed by an inherited circular member at the lower end of said chute for said buffer stop to hold against said conic stopper of said positioning member.

4. A multiple-direction bendable tube structure as claimed in claim 1, wherein, both ends of said elastic cord are respectively connected to said fixing member attached to the end where said secondary section enters said primary section, and to said buffer stop inside said primary tube for restricting slide so that both said fixing member and said buffer stop are abutted at a short range due to the pull by said elastic cord.

5. A multiple-direction bendable tube structure as claimed in claim 4, wherein, a convex and a concave are respectively provided at the abutted ends of said fixing member and said buffer stop.
